(19) United States
(12) Patent Application Publication
(10) Pub. No.: US 2001/0022667 A1
(43) Pub. Date: Sep. 20, 2001

(54) Method, apparatus, and recording medium for outputting images

(76) Inventor: Akira Yoda, Kaisei-machi (JP)

Correspondence Address: BIRCH STEWART KOLASCH & BIRCH, PO BOX 747, FALLS CHURCH, VA, 22040-0747, US

(21) Appl. No.: 09/801,649

(22) Filed: Mar. 9, 2001

(30) Foreign Application Priority Data
Mar. 9, 2000 (JP) 065276/2000

(51) Int. Cl. B41B 1/00

(52) U.S. Cl. 358/1.14

(57) ABSTRACT

A copied print giving the same impression as the original is generated. ID information is embedded in original picture data and stored in storage means while an original picture is printed and provided to a user. The user generates an original image by using the original picture and requests printing of the original image from a laboratory. In the laboratory, reading means reads the original image and reads the ID information from the original picture included in the original image. The original picture data corresponding to the ID information are read from the storage means to be used for generating composite image data. At this time, matching is carried out between initial image data representing the original image and the original picture data, and the original picture is positioned to be pasted on the composite image data. The composite image data are printed by a printer.

### BACKGROUND OF THE INVENTION

1. Field of the Invention

The present invention relates to an image output method and an image output apparatus for obtaining a print based on image data. The present invention also relates to a computer-readable recording medium storing a program to cause a computer to execute the image output method.

2. Description of the Related Art

Additional prints of photographs have been obtained by using negative films, as has been described in Japanese Unexamined Patent Publication No. 2(1990)-214836, for example. Recently, additional prints of photographs are generated by using image data obtained by digital cameras or by photoelectrically reading films. However, since management of image data is difficult, only prints rather than image data, are stored in general households. Even though image data are stored, correlation between prints and image data stored in a hard disc or the like of a personal computer is difficult, since no file names of the image data are indicated on the prints in albums or the like.

As has been described above, prints are not often stored in relation to image data. Therefore, in order to obtain additional prints, the prints are photoelectrically read by a scanner and image data are obtained. Copies of the prints are then generated by a digital printer or the like from the image data, as has been described in Japanese Unexamined Patent Publication No. 7(1995)-254988, for example. Furthermore, in order to meet demands for copying prints having characters or the like written thereon and for copying documents or albums having prints therein, copies of prints are generated by using image data obtained by reading the original.

However, a plurality of factors causing image quality degradation, such as defocus and flare of an optical system of a scanner, and degradation or noise of an imaging device upon sampling, are included in the method of generating copies of prints described in Japanese Unexamined Patent Publication No. 7(1995)-254988. Furthermore, scars and stains such as fingerprints easily occur on the original, and colors also degrade due to fading and alteration overtime. Moreover, in the case of using a digital print or a printed matter as the original, moiré occurs on a copied print due to interaction between scanning lines or halftone dots forming an image and scanning lines of a scanner. Therefore, quality degradation of a copied print generated by reading the original cannot be avoided, and the degradation worsens in the case where a copied print is generated from a copied print. In this case, if a scanner having a desirable optical characteristic is used, the degradation can be suppressed to some degree. However, such a scanner is expensive and cannot completely suppress the degradation.

For this reason, an image forming method for generating a copied print has been proposed (Japanese Unexamined Patent Publication No. 8(1996)-331362). In this method, an ID number of an original image is given to the image in a state where the ID number is not discernable by human eyes, and this ID number is extracted when the original image is read by a scanner. Image data corresponding to the ID number are read from storage means storing the image data in relation to the ID number. By using the image data that have been read, a copied print is generated. If this method is applied to a copied print, original image data not obtained by reading are used for generating a copied print, although the original is actually read. Therefore, a copied print not having quality degradation can be obtained.

However, in some cases, an image recorded in an original image has been printed by a printer having a resolution different from a resolution of the copied print. In other cases, an image recorded on the original has been generated by carrying out manipulation on an original image, such as cropping and scaling. In such a case, if original image data are printed as they are, a size and a range of the image in a copied print differ from those in the original. Especially, in the case where an image has a handwritten comment in a margin thereof or in the case where the original is a composite image having another image or text laid out therein, a copied print not giving an identical impression of the original may be generated if original image data are printed as they are.

### SUMMARY OF THE INVENTION

The present invention has been conceived based on consideration of the above problems. An object of the present invention is therefore to provide an image output method and an image output apparatus for obtaining a copied print giving the same impression as an original image, and to provide a computer-readable recording medium storing a program to cause a computer to execute the image output method.

The image output method of the present invention comprises the steps of:

obtaining initial image data representing an initial image recorded in an original image and ID information for identifying an original picture by reading the original image having the original picture and the ID information inseparable from the original picture;

reading equivalent original picture data representing an equivalent original picture corresponding to the ID information from storage means storing a plurality of sets of original picture data having ID information related thereto;

comparing the initial image data with the equivalent original picture data and obtaining processed image data by carrying out processing on the equivalent original picture data to cause the equivalent original picture to geometrically agree with the original picture in the initial image; and

obtaining a print by printing the processed image data.

The “ID information” refers to any information by which the original picture can be identified, such as an ID number or a file name of the original picture data.

The “ID information inseparable from the original picture” refers to ID information printed by using a bar code or a number at a margin of the original image if the original image has the margin, or on the back of the original image, for example. However, it is preferable for the ID information to be embedded secretly in the initial image in the original image based on consideration of the case where the original image has been generated by pasting the original picture on a mount or the original image does not have the margin, or the original image is double-sided or a composite image having characters and an illustration, for example. Various references are available for a method of secretly embedding information in an image (see Kineo Matsui, 1997, “Electronic watermark” (in Japanese), O Plus E No. 213, for example).

The “processing to cause the equivalent original picture to geometrically agree with the original picture in the initial image” refers to processing such as scaling, translation, rotation, and cropping on the equivalent original picture to cause the equivalent original picture to agree with the original picture in the initial image.

It is preferable for the image output method of the present invention to further comprise the step of carrying out processing for preventing copying on the processed image data and/or the print.

“Carrying out processing for preventing copying on the processed image data” refers to secretly embedding, in the processed image data, information indicating that the processed image data have been generated by copying, for example.

“Carrying out processing for preventing copying on the print” refers to applying a copyguard by using microlines on a base material of the print or by forming a microline-like pattern on a surface of a photosensitive material, for example.

In the image output method of the present invention, it is preferable for a copyright of the original picture to be managed based on the ID information.

Management of the copyright refers to prohibiting copying of the original picture or charging a fee for the copyright if the original picture has the copyright.

An image output apparatus of the present invention comprises:

reading means for obtaining initial image data representing an initial image recorded in an original image and ID information for identifying an original picture by reading the original image having the original picture and the ID information inseparable from the original picture;

storage means for storing a plurality of sets of original picture data in relation to ID information;

reading means for reading equivalent original picture data representing an equivalent original picture corresponding to the ID information of the original picture from the storage means;

processing means for obtaining processed image data by comparing the initial image data with the equivalent original picture data and carrying out processing on the equivalent original picture data to cause the equivalent original picture to geometrically agree with the original picture in the initial image; and

output means for obtaining a print by printing the processed image data.

In the image output apparatus of the present invention, it is preferable for the ID information to be secretly embedded in the initial image.

Furthermore, it is preferable for the image output apparatus of the present invention to further comprise copying prevention processing means for carrying out processing to prevent copying on the processed image data and/or on the print.

Moreover, it is also preferable for the image output apparatus of the present invention to further comprise information management means for managing a copyright of the original picture based on the ID information.

The image output method of the present invention may be provided as a program recorded in a computer-readable recording medium to cause a computer to execute the method.

According to the present invention, the initial image data representing the initial image and the ID information for identifying the original picture are obtained by reading the original image, and the equivalent original picture data related to the ID information are read from the storage means. The equivalent original picture data and the initial image data are then compared to each other and the processed image data are obtained after carrying out the processing on the equivalent original picture data to cause the equivalent original picture to geometrically agree with the original picture in the initial image. The processed image data are then printed and the print is generated. Therefore, the print having the original picture giving the same impression as the initial image can be obtained even in the case where the image included in the initial image has been generated by manipulation such as trimming, scaling, and rotation on the original picture, or by composition with another image or characters.

Furthermore, by secretly embedding the ID information in the original picture, the ID information can be added to the original picture without being known by others.

Moreover, by carrying out the processing to prevent copying on the processed image data and/or on the print, the print generated by using the present invention can be prevented from being copied.

By managing the copyright of the original picture, the original picture can be prevented from being copied illegally if the original picture is copyrighted.

### BRIEF DESCRIPTION OF THE DRAWINGS

FIG. 1 is a block diagram showing an outline configuration of an image output system as an embodiment of the present invention;

FIGS. 2A and 2B are diagrams explaining positions of subplanes;

FIG. 3 shows modulation patterns;

FIG. 4 shows other modulation patterns;

FIG. 5 shows an example of an original picture;

FIG. 6 shows an example of an original image;

FIG. 7 is a flow chart showing operation of this embodiment (part 1);

FIG. 8 is a flow chart showing the operation of this embodiment (part 2); and

FIG. 9 is a partial enlargement of printing paper having microlines printed thereon.

### DESCRIPTION OF THE PREFERRED EMBODIMENT

Hereinafter, an embodiment of the present invention will be explained with reference to the accompanying drawings.

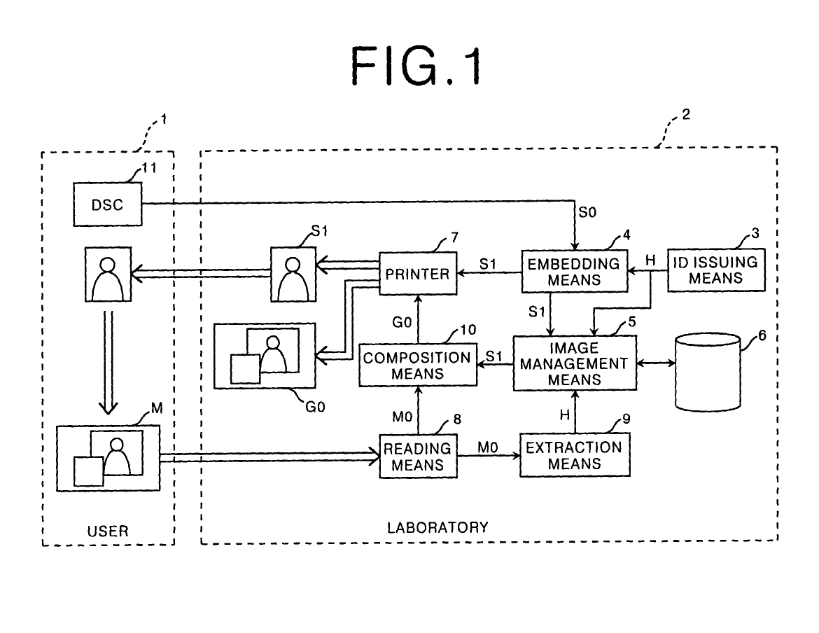

FIG. 1 is a block diagram showing an outline configuration of an image output system adopting an image output apparatus as an embodiment of the present invention. As shown in FIG. 1, the image output system in this embodiment exchanges data and prints between a user 1 and a laboratory 2. The image output system comprises ID issuing means 3 for issuing ID information H to be added to original picture data S0 obtained by a digital camera (DSC) 11 of the user 1, embedding means 4 for generating original picture data S1 embedded with the ID information H, image management means 5 for managing the original picture data S1 and the ID information H, storage means 6 for storing the original picture data S1 and the ID information H by relating the data to the information, a printer 7 for printing a composite image represented by composite image data G0 which will be explained later (hereinafter, the composite image is also called G0) and printing an original picture represented by the original picture data S1 (hereinafter, the original picture is also called S1), reading means 8 such as a scanner for obtaining initial image data M0 representing an initial image M0 by reading an original image M generated by the user 1 by using the original picture S1, extraction means 9 for extracting the ID information H from the initial image data M0, and composition means 10 for generating the composite image data G0 representing the composite image corresponding to the original image M based on the initial image data M0 and the original picture data S1 read from the storage means 6 based on the ID information H extracted from the initial image data M0.

The user 1 may provide the original picture data S0 obtained by the digital camera 11 to the laboratory 2 by recording the data in a recording medium such as an FD, or via a network.

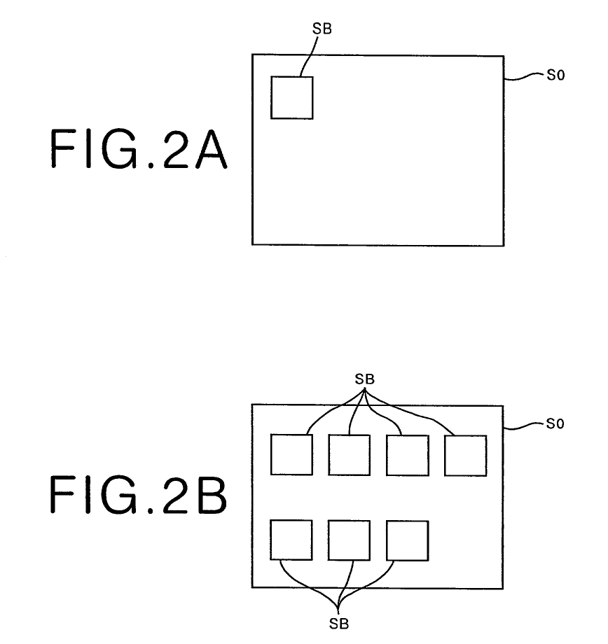

The embedding means 4 secretly embeds the ID information H issued by the ID issuing means 3 in the original picture data S0, and obtains the original picture data S1 having the ID information H embedded therein. Hereinafter, how the ID information H is embedded by the embedding means 4 will be explained. An original picture S0 represented by the original picture data S0 is an image comprising m×n pixels of 8-bit RGB data. First, subplanes SB each comprising p×q pixels (p<m, q<n) are generated at several-pixel intervals from the original picture S0. The number of the subplanes SB in the original picture S0 may be 1 as shown in FIG. 2A, or larger than 1 as shown in FIG. 2B. In this embodiment, seven subplanes SB are used as shown in FIG. 2B. Eight bits, comprising the lower three bits of each of the R channel and B channel and the lower two bits of the G channel, are used as a bit plane of the ID information H to be embedded.

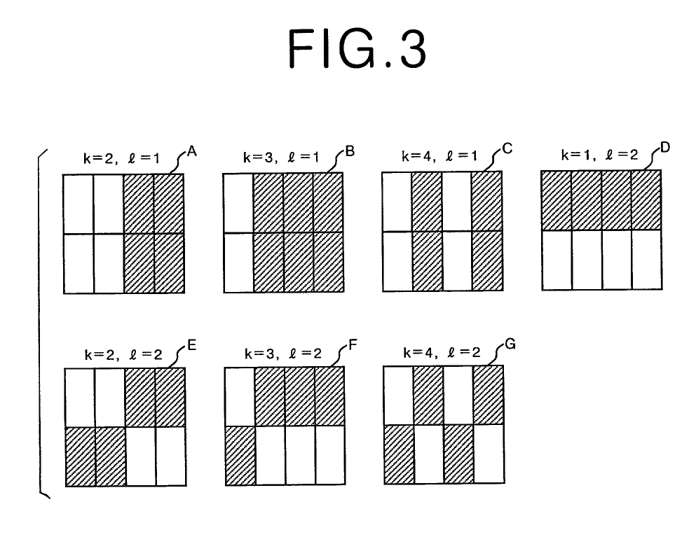

If the ID information H is described in 16 bits, 7 bits each are assigned to the R and B channels while 2 bits are assigned to the G channel. The number of bits assigned to the G channel is smaller than the number of bits assigned to the R channel or the B channel, since human eyes are most sensitive to the G channel. First, how the information is embedded in the R channel will be explained. Since the 7-bit information is embedded in the R channel, seven types of modulation patterns are prepared for an area of p×q pixels which has the same size as the subplanes SB. For example, as shown in FIG. 3, each of the subplanes SB is divided into 8 areas, and 7 types of modulation patterns A˜G modulated in a period of 2p/k (k=1, 2, 3, 4) in an x direction and 2q/l (l=1, 2) in a y direction are used for the areas. The case of k=l=1 is not used as the modulation pattern. If each of the subplanes SB is divided into 8 areas as shown in FIG. 3, the information can be embedded in each of the areas, which will be explained later, as long as each of the areas has one pixel. Therefore, the subplanes SB having at least 4×2 pixels each are sufficient.

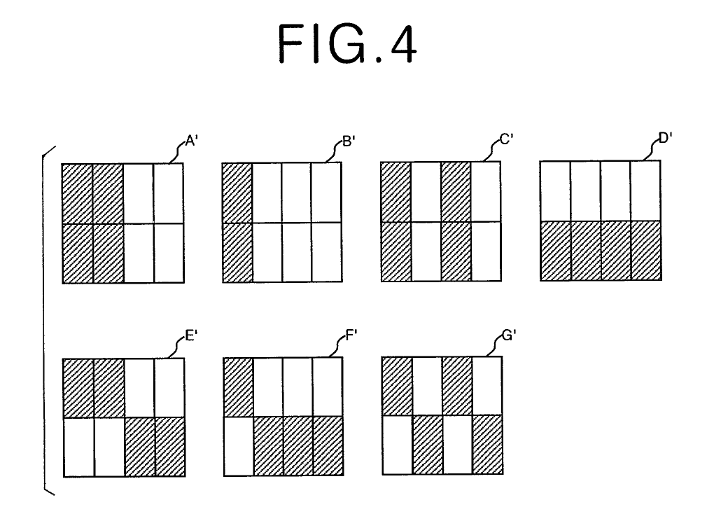

A state of ON or OFF of hatched areas of the seven modulation patterns A˜G corresponds to 1 or 0 of the 7 bits assigned to the R channel, while the number of the areas being ON is used as a pixel value of the hatched areas. In this manner, the 7-bit information can be embedded in the subplanes SB having the p×q pixels each. In other words, if the hatched areas in the patterns A˜G shown in FIG. 3 are ON and the others are OFF while hatched areas in patterns A′˜G′ shown in FIG. 4 wherein the patterns A˜G in FIG. 3 are inverted are ON and the others are OFF, the 7-bit information can be represented by using the patterns. In each of the patterns A˜G and A′˜G′, the number of the ON pixels takes a value ranging from 0 to 7. Therefore, if the number of the hatched areas is used as the pixel value of the hatched areas, the pixel value of the hatched areas takes a value ranging from 0 to 7, and can be embedded in the pixel values of the lower 3 bits of the R channel in each of the subplanes SB.

For the B channel, the 7-bit information can be embedded in the lower 3 bits, as in the case of the R channel. Meanwhile, for the G channel, each of the subplanes SB having the p×q pixels is divided into two areas and two modulation patterns are used. By switching on and off the modulated areas, the 2-bit information can be represented. The number of the ON areas can vary between 0 and 2. Therefore, the 2-bit information can be embedded in the subplanes SB as the pixel value of the lower 2 bits of the G channel.

By embedding the 16-bit ID information H in the RGB channels of the original picture data S0 as has been described above, the original picture data S1 having the ID information H can be obtained. Since the ID information H is embedded dispersedly in the lower 3 bits and the lower 2 bits of the RGB channels, the ID information can hardly be perceived by human eyes even if the original picture data S1 are reproduced.

The image management means 5 has functions of storing the original picture data S1 and the ID information H in the storage means 6 by relating the data and the information to each other, and searching for the original picture data S1 stored in the storage means 6 based on the ID information H. The image management means 5 searches for the original picture data S1 corresponding to the ID information H extracted by the extraction means 9 as will be explained later, and reads the image data S1 from the storage means 6.

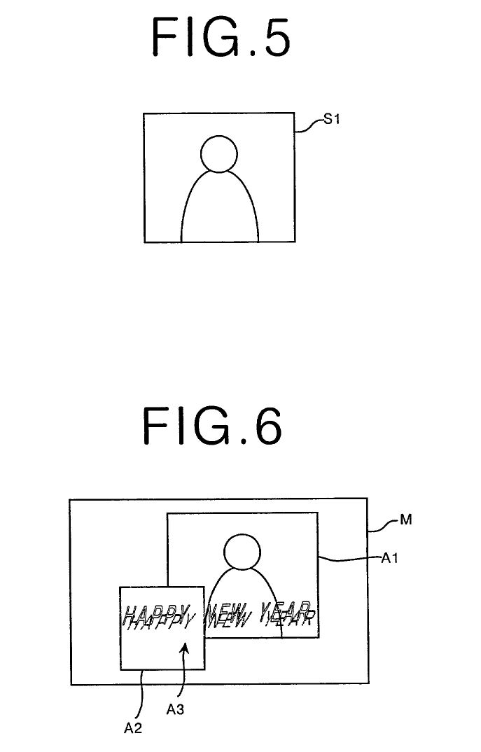

The user 1 generates the original image (composite image) M by using the original picture S1 printed by the printer 7. However, the user 1 may generate the original image M by pasting another image or characters or the like with the original picture S1. Alternatively, the user 1 may obtain image data by reading the original picture S1 with a scanner and manipulate the image data with a personal computer. In this manner, the user 1 can generate the original image M by printing the manipulated data. In this embodiment, the original picture S1 is as shown in FIG. 5 and the original image M is a composite image comprising an image A1 corresponding to the original picture S1, another image A2, and a character image A3, as shown in FIG. 6. The original image M is not limited to the example shown in FIG. 6 and can be an image generated only by trimming, scaling, or rotation of the original picture S1, for example.

The extraction means 9 recognizes the images A1˜A3 in the initial image data M0 obtained by reading the original image M with the reading means 8. The extraction means 9 judges whether the ID information H is embedded in the images A1˜A3 and extracts the ID information H from the image having the information. In other words, the extraction means 9 extracts the bit planes of the lower 3 bits each of the R and B channels and the lower 2 bits of the G channel from the initial image data M0 and judges whether the modulated subplanes SB shown in FIG. 3 or 4 are included in the bit planes. In this manner, the extraction means 9 can judge which of the images A1˜A3 has the ID information H. By finding a correlation through pattern matching between the modulation patterns of the subplanes SB and the modulation patterns shown in FIGS. 3 and 4 for the image having the ID information H (the image A1 in this case), the extraction means can find which of the modulation patterns is embedded. Therefore, by carrying out the pattern matching for the lower bit planes of the RGB channels, the 16-bit information can be obtained as the ID information H.

The composition means 10 judges which of the images A1˜A3 of the initial image data M0 has the embedded ID information H as the extraction means 9 does, and carries out composition processing on the original picture data S1 input from the image management means 5 and on the other images, in order to replace the image having the ID information H. A result of the judgment by the extraction means 9 may be input to the composition means 10 so that the composition means 10 does not need to judge whether the ID information H is embedded. The composition processing is carried out in the following manner. First, an area corresponding to the image A1 in the initial image data M0 is set as a position matching target area and pattern matching is carried out with the original picture data S1 in the position matching target area. The pattern matching is carried out by finding a difference between the data in the position matching target area and in the original picture data S1 while geometric processing such as scaling, rotation, cropping and translation is carried out on the original picture data S1. An area having a smallest difference from the initial image data M0 is replaced with the original picture data S1, and the composite image data G0 are obtained.

In the original image M, the image A2 is laid out onto the image A1, and the character image A3 representing “Happy New Year” also overlaps at a boundary therebetween. In the pattern matching described above, the difference becomes larger for the areas in which the image A2 and A3 are laid out on the image A1 than for areas other than these areas. Therefore, by applying the replacement with the original picture data S1 that have been subjected to the geometric processing only to the areas having the smallest difference, the composite image data G0 can be obtained without damaging the areas of the image A1 covering the images A2 and A3.

In this embodiment, since only the original picture data S1 corresponding to the image A1 are input to the composition means 10, portions of the initial image data M0 corresponding to the images A2 and A3 are used for generating the composite image data G0.

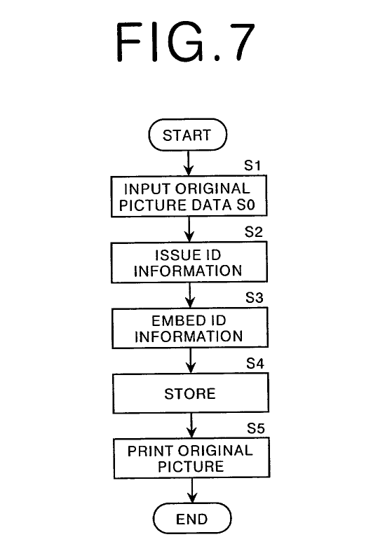

Operation of this embodiment will be explained next. FIG. 7 is a flow chart showing operation until the original picture data S1 are printed. The original picture data S0 of the user 1 obtained by the digital camera 11 are input to the embedding means 4 (Step S1), and the ID information H is issued by the ID issuing means 3 (Step S2). The embedding means 4 embeds the ID information H in the original picture data S0, and the original picture data S1 having the ID information embedded therein are obtained (Step S3). The original picture data S1 and the ID information H are input to the image management means 5 and stored in the storage means 6 by being related to each other (Step S4). Meanwhile, the original picture data S1 are input to the printer 7 and the original picture S1 shown in FIG. 5 is printed (Step S5). The above is the processing until the original picture S1 is printed.

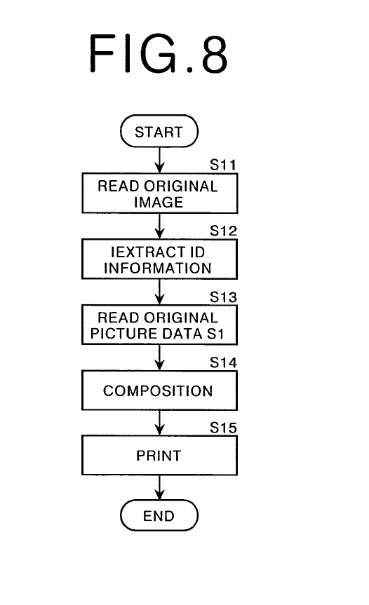

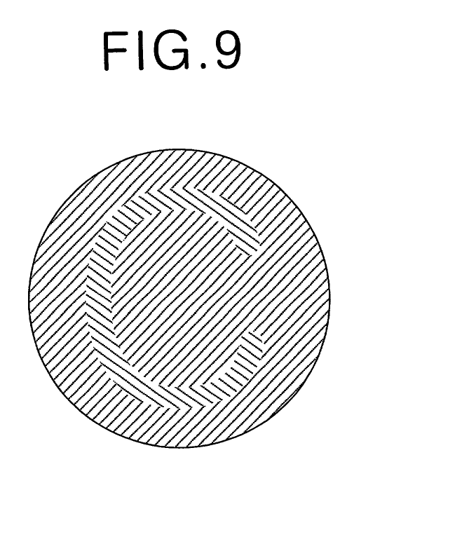

The printed original picture S1 is provided to the user 1. The user 1 generates the original image M shown in FIG. 6 by manipulating the original picture S1 provided thereto. The original image M generated by the user 1 is then provided to the laboratory 2. FIG. 8 is a flow chart showing processing using the original image M. In the laboratory 2, the reading means 8 reads the original image M, and the initial image data M0 representing the initial image in the original image M are obtained (Step S11). The initial image data M0 are input to the extraction means 9 and the ID information H is extracted in the manner described above (Step S12). The extracted ID information H is input to the image management means 5 and the original picture data S1 corresponding to the ID information H are read from the storage means 6 (Step S13). The original picture data S1 are input to the composition means 10 and the pattern matching is carried out with the initial image data M0. The composite image data G0 are then generated from the original picture data S1 and the initial image data M0 (Step S14). The composite image data G0 are printed by the printer 7 (Step S15) to end the procedure.

As has been described above, in this embodiment, the initial image M0 is compared with the original picture S1 and the composite image G0 is generated by replacing the image A1 in the initial image M0 with the original picture S1 after the pattern matching. Therefore, even in the case where the image A1 included in the initial image M0 has been generated by carrying out processing such as cropping, scaling, or rotation on the original picture S1, or even in the case where the image A1 has been laid out with the other images A2 and A3, the composite image G0 including the high-quality original picture S1 which gives the same impression as the initial image M0 can be obtained.

Furthermore, by secretly embedding the ID information H in the original picture S0 by using the embedding means 4, the ID information H can be added to the original picture S0 without being known.

In the above embodiment, the 7-bit information is embedded by using the modulation patterns shown in FIGS. 3 and 4. However, by dividing the area of p×q pixels in the subplane SB into seven areas and by generating modulation patterns of ON (=1) and OFF (=0) for the areas, the 7-bit information can also be embedded in the subplane SB. In this case, if the number of the areas being ON is the same as the pixel value of the areas, the pixel value can range from 0 to 7. Therefore, the information can be embedded in the lower 3 bits of R and B as in the above embodiment. In this case, by using a plurality of the subplanes SB in the original picture S1, the original picture data S1 representing the original picture S1 can be read if at least one of the subplanes SB exists, even in the case where the printed original picture S1 is partially damaged, for example.

In the above embodiment, information indicating that the original picture S1 included in the composite image G0 is a copy may be embedded in the composite image data G0 upon generation thereof. By embedding the information indicating a copy in the composite image data G0, the composite image G0 can be easily known as a copy by reading the composite image data G0. Therefore, illegal copying can be prevented.

As the information indicating a copy, printing paper having a copyguard may be used when the composite image G0 is printed. As the copyguard, microlines are preferably used. FIG. 9 shows a partial enlargement of printing paper having the microlines printed thereon. The microlines are printed as stripes of 50˜300-micron pitch on a base material by using a comparatively light color such as yellow or light blue. Such microline patterns have constant reflectivity on average and small density contrast. Therefore, the printing paper looks like printing paper colored uniformly and lightly. However, when the printing paper is read by a scanner, resolution does not agree completely between directions of main scan and vertical scan. Therefore, if a direction of diagonal lines of a “C”-like pattern shown in FIG. 9 is different from a direction of diagonal lines surrounding the pattern, the portion is read as a portion having density different from the surrounding. As a result, by reading the composite image G0 printed on the printing paper with a scanner, the pattern of the microlines appears, which shows the composite image to be a copy. In this manner, illegal copying can be prevented.

In the case of a photograph, a photosensitive material is glossy. Therefore, even if the microlines are printed on the photosensitive material, the lines can hardly be read by a scanner. For this reason, a cover layer made of polyethylene is used on a surface of a gelatin layer of the photosensitive material and irregularity having the same pattern as the microlines is formed therein. In this manner, the information indicating a copy can be added to the photosensitive material, as in the case of the printing paper. In this case, the patterns are not colored. However, when the photosensitive material is read, anisotropy occurs in a scattering pattern of reflected light, and the difference in the lines appears as the same pattern as the microlines in the image that has been read.

In the above embodiment, if the original picture S1 has a copyright, the image management means 5 may comprise copyright management means so that copyright information of the original picture S1 can be managed based on the ID information H of the original picture S1. For example, if the personal computer of the user 1 and the laboratory 2 are connected to each other via a network and if printing of the original picture S1 having the copyright is requested, information indicating a charge for the copyright may be transferred to the user 1. Printing is carried out after information indicating agreement to payment for the copyright is transferred form the user 1. Alternatively, information indicating that the image cannot be copied because of the copyright can also be transferred to the user 1. In this manner, illegal copying of the image having the copyright can be prevented.

Furthermore, the image A1 can be replaced with another image different from the original picture S1 initially requested by the user 1. This replacement can be applied to the case where the user 1 instructs to the laboratory 2 replacement of the original picture S1 having the copyright in the original image M with another image not having a copyright after receiving the information indicating copying is not allowed. The composition means 10 carries out matching between the initial image data M0 and the original picture data S1 and generates a mask area corresponding to the original picture S1. The composition means 10 inserts an image not having a copyright in the mask area and the images can be exchanged accurately at a correct position.

In the above embodiment, since the image A2 is over the image A1 in the overlap area, the image A2 is printed over the image A1 in the composite image G0. However, in response to a request of the user 1, the composite image G0 may be generated in such a manner that the image A1, that is, the original picture S1, is over the image A2. In this case, the original picture data S1 are pasted on the initial image data M0 as they are after the pattern matching by the composition means 10. In this manner, the composite image G0 having the original picture S1 over the image A2 can be obtained as requested.

In the above embodiment, the laboratory 2 has the printer 7. However, if a printer exists at a location other than the laboratory 2, it is preferable for the composite image data G0 to be transferred to the printer after being coded, in order to prevent copying the composite image data G0. By introducing a decoding function to the printer having a right to print, the composite image data G0 can be printed only by the printer having the right. Therefore, illegal copying of the composite image data G0 can be prevented.

In the above embodiment, the ID information H is secretly embedded in the original picture data S0. However, the ID information H may be printed on the back of the print by using a bar code or characters. In the case where the print has a white margin, the ID information H can be printed on the margin. In this case, the reading means 8 reads the ID information H recorded on the original image M and inputs the information to the image management means 5. The image management means 5 searches for the original picture data S1 based on the ID information H input thereto.

In the above embodiment, not only the image A1 in the original image M but also the image A2 may use the original picture S1 having the ID information H embedded therein.

What is claimed is:

1. An image output method comprising the steps of:
obtaining initial image data representing an initial image recorded in an original image and ID information for identifying an original picture by reading the original image having the original picture and the ID information inseparable from the original picture;
reading equivalent original picture data representing an equivalent original picture corresponding to the ID information from storage means storing a plurality of sets of original picture data having ID information related thereto;
comparing the initial image data with the equivalent original picture data and obtaining processed image data by carrying out processing on the equivalent original picture data to cause the equivalent original picture to geometrically agree with the original picture in the initial image; and
obtaining a print by printing the processed image data.

2. An image output method as defined in claim 1, wherein the ID information is secretly embedded in the initial image.

3. An image output method as defined in claim 1, further comprising the step of carrying out copying prevention processing on the processed image data and/or on the print.

4. An image output method as defined in claim 2, further comprising the step of carrying out copying prevention processing on the processed image data and/or on the print.

5. An image output method as defined in any one of claims 1 to 4, further comprising the step of managing a copyright of the original picture based on the ID information.

6. An image output apparatus comprising:
reading means for obtaining initial image data representing an initial image recorded in an original image and ID information for identifying an original picture by reading the original image having the original picture and the ID information inseparable from the original picture;
storage means for storing a plurality of sets of original picture data in relation to ID information;
reading means for reading equivalent original picture data representing an equivalent original picture corresponding to the ID information of the original picture from the storage means;
processing means for obtaining processed image data by comparing the initial image data with the equivalent original picture data and carrying out processing on the equivalent original picture data to cause the equivalent original picture to geometrically agree with the original picture in the initial image; and
output means for obtaining a print by printing the processed image data.

7. An image output apparatus as defined in claim 6, wherein the ID information is secretly embedded in the initial image.

8. An image output apparatus as defined in claim 6, further comprising copying prevention processing means for carrying out processing to prevent copying on the processed image data and/or on the print.

9. An image output apparatus as defined in claim 7, further comprising copying prevention processing means for carrying out processing to prevent copying on the processed image data and/or on the print.

10. An image output apparatus as defined in any one of claims 6 to 9, further comprising information management means for managing a copyright of the original picture based on the ID information.

11. A computer-readable recording medium storing a program to cause a computer to execute the procedures of:
obtaining initial image data representing an initial image recorded in an original image and ID information for identifying an original picture by reading the original image having the original picture and the ID information inseparable from the original picture;
reading equivalent original picture data representing an equivalent original picture corresponding to the ID information from storage means storing a plurality of sets of original picture data having ID information related thereto;
comparing the initial image data with the equivalent original picture data and obtaining processed image data by carrying out processing on the equivalent original picture data to cause the equivalent original picture to geometrically agree with the original picture in the initial image; and
obtaining a print by printing the processed image data.

12. A computer-readable recording medium as defined in claim 11, wherein the ID information is secretly embedded in the initial image.

13. A computer-readable recording medium as defined in claim 11, the program further comprising the procedure of carrying out copying prevention processing on the processed image data and/or on the print.

14. A computer-readable recording medium as defined in claim 12, the program further comprising the procedure of carrying out copying prevention processing on the processed image data and/or on the print.

15. A computer-readable recording medium as defined in any one of claims 11 to 14, the program further comprising the procedure of managing a copyright of the original picture based on the ID information.
